(19) United States
(12) Patent Application Publication
(10) Pub. No.: US 2025/0306705 A1
(43) Pub. Date: Oct. 2, 2025

(54) DISPLAY DEVICE, IMAGE PROCESSING DEVICE AND IMAGE DISPLAY METHOD

(71) Applicant: E Ink Holdings Inc., HSINCHU (TW)

(72) Inventors: Hsiao-Lung CHENG, HSINCHU (TW); Shu-Cheng LIU, HSINCHU (TW); Pei-Lin TIEN, HSINCHU (TW)

(21) Appl. No.: 19/082,206

(22) Filed: Mar. 18, 2025

(30) Foreign Application Priority Data
Mar. 27, 2024 (TW) 113111558

(51) Int. Cl. G06F 3/041; G06F 3/044

(52) U.S. Cl. CPC G06F 3/04166; G06F 3/044

(57) ABSTRACT

An image processing device, comprising a touch circuit and a driving circuit. The touch circuit is configured to obtain a plurality of touch signals in a plurality of touch frames. The driving circuit is coupled to the touch circuit to obtain the plurality of touch signals, and is coupled to a display panel through a plurality of scan lines. The driving circuit is configured to scan a first part of the plurality of scan lines in a first display frame according to the plurality of touch signals to update a first image in a first area of the display panel. The driving circuit is configured to scan a second part of the plurality of scan lines in a second display frame according to the plurality of touch signals to update the first image in a second area of the display panel.

### CROSS-REFERENCE TO RELATED APPLICATION

This application claims priority to Taiwan Application Serial Number 113111558, filed Mar. 27, 2024, which is herein incorporated by reference in its entirety.

### BACKGROUND

### Technical Field

The present disclosure relates to an image display technology, and in particular to a display device, an image processing device and an image display method.

### Description of Related Art

In various consumer electronics markets, “reflective display device” is widely used to implement the display screen, such as electronic paper display devices. The reflective display device mainly uses incident light to illuminate a display medium layer to achieve the purpose of display, so it can save power. The display device is often used in combination with a touch device to allow user to input signals using touch. Therefore, how to make the update speed of the display device match the signal input speed of user has become an important factor affecting the user experience.

### SUMMARY

One aspect of the present disclosure is an image processing device, comprising a touch circuit and a driving circuit. The touch circuit is configured to obtain a plurality of touch signals in a plurality of touch frames. The driving circuit is coupled to the touch circuit to obtain the plurality of touch signals, and is coupled to a display panel through a plurality of scan lines. The driving circuit is configured to scan a first part of the plurality of scan lines in a first display frame according to the plurality of touch signals to update a first image in a first area of the display panel. The driving circuit is configured to scan a second part of the plurality of scan lines in a second display frame according to the plurality of touch signals to update the first image in a second area of the display panel.

Another aspect of the present disclosure is an image display method, comprising: obtaining, by a touch circuit, a plurality of touch signals in a plurality of touch frames; scanning, by a driving circuit, a first part of a plurality of scan lines of a display panel in a first display frame according to the plurality of touch signals to update a first image in a first area of the display panel; and scanning, by the driving circuit, a second part of the plurality of scan lines in a second display frame according to the plurality of touch signals to update the first image in a second area of the display panel.

Another aspect of the present disclosure is a display device, comprising a display panel and a driving circuit. The driving circuit is coupled to a touch circuit to obtain a plurality of touch signals, and is coupled to a display panel through a plurality of scan lines. The driving circuit is configured to scan a first part of the plurality of scan lines in a first display frame according to the plurality of touch signals to update a first image in a first area of the display panel. The driving circuit is configured to scan a second part of the plurality of scan lines in a second display frame according to the plurality of touch signals to update the first image in a second area of the display panel.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a display device in some embodiments of the present disclosure.

FIG. 2A is a schematic diagram of touch frames and display frames in some embodiments of the present disclosure.

FIG. 2B is a schematic diagram of touch frames and display frames in some embodiments of the present disclosure.

FIG. 3A is a schematic diagram of different areas of the display panel in some embodiments of the present disclosure.

FIG. 3B is a schematic diagram of different areas of the display panel in some embodiments of the present disclosure.

FIGS. 4A-4C are schematic diagrams of image update in some embodiments of the present disclosure.

FIG. 5 is a flowchart illustrating an image display method a projection method in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

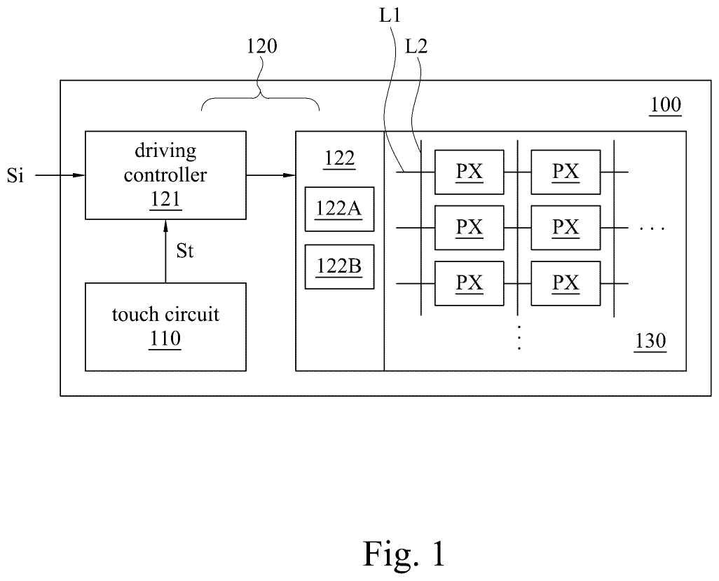

FIG. 1 is a schematic diagram of a display device 100 in some embodiments of the present disclosure. The display device 100 can be a reflective display device (e.g., electronic paper display device), but the present disclosure is not limited to this, and can also be applied to other types of displays.

The display device 100 includes a touch circuit 110, a driving circuit 120 and a display panel 130. The touch circuit 110 includes multiple touch electrodes, and is configured to transmit and receive a sensing signal to detect changes in impedance or capacitance (i.e., a touch signal), and then determine the position and trajectory of a foreign object (e.g., user's finger or stylus) when the foreign object contacts the display device 100. In one embodiment, the touch circuit 110 transmits and receives the sensing signal according to a preset sensing frequency, and generates/obtains a touch signal St according to the sensing result. In other words, the touch circuit 110 obtains multiple touch signals St in multiple frame periods (herein referred to as “touch frame”).

The touch circuit 110 can be implemented to a touch panel, but is not limited to an independent panel structure. The touch circuit 110 can also be a circuit module integrated in the display device 100, such as an in-cell touch panel. Specifically, a processor of the touch circuit 110 can transmit multiple sensing signals to multiple first touch electrodes and receive multiple response signals from multiple second touch electrodes. When the foreign object contacts the display device 100, a mutual capacitance between the first touch electrodes and the second touch electrodes will change, and the signal strength of the sensing signals represents changes in these mutual capacitance values. Therefore, the processor of the touch circuit 110 can calculate the X-axis position and Y-axis position of the touch position on the display device 100 according to the sensing signals.

The driving circuit 120 is coupled to the touch circuit 110 to obtain the touch signal St provided by the touch circuit 110. The driving circuit 120 is further coupled to multiple pixel circuits PX in the display panel 130 through multiple scan lines L1 and multiple data lines L2, so as to provide a driving voltage to the corresponding pixel circuit PX and control the brightness, gray scale or color presented by the pixel circuits PX. In one embodiment, the driving circuit 120 drives the display panel 130 according to a set scanning frequency. Each frame period in which the display panel 130 updates the screen will be called “display frame” to distinguish it from the above “touch frame”.

The driving circuit 120 provides a driving voltage to the display panel 130 according to the received image signal Si. In one embodiment, the image signal Si can be transmitted to the display device 100 by a host device (not shown in the figure, such as a computer, a mobile phone or a network server, etc.). The image signal can also be generated by the display device 100 (e.g., reading data in an internal memory to generate the image signal).

In addition, the driving circuit 120 can further generate the driving voltage according to the received touch signal St to drive the display panel 130 to update the screen. For example, when the user inputs commands through the touch circuit 110 (e.g., uses gestures to write notes), the driving circuit 120 recognizes the corresponding image (e.g., letters “ABC”) according to the touch signal St, and accordingly provides the corresponding driving voltages to the pixel circuits PX at the corresponding positions to display the update of the screen.

In one embodiment, the driving circuit 120 includes a driving controller 121 and a timing controller 122. The driving controller 121 can be a SoC (System on a Chip), includes a driver module and an operating system (OS). The timing controller 122 can be an integration of a timing control circuit (Timing Controller) and a scan driver circuit. The timing control circuit is configured to output a clock related signal to the scan driver circuit, which scans the display panel 130 according to a set scanning sequence.

In one embodiment, the display panel 130 can be a reflective display panel, such as an electrophoretic display device (electronic paper), but the present disclosure is not limited to this, and the display panel 130 can also be applied to other types of displays. The electrophoretic display device includes a transistor array layer and an electronic ink layer. The transistor array layer (e.g., thin film transistor array, TFT array) can form an electric field according to a control voltage to adjust multiple positions of multiple electrophoretic particles in the electronic ink layer, so as to present different gray scales or different colors. The electronic ink layer includes multiple electrophoretic particles, and the electrophoretic particles belong to different types (e.g., black, white), which are separately encapsulated in multiple microcapsules or microcups to form a pixel unit. Since one of ordinary skill in the art can understand the circuit structure and the principle of the display panel, and thus they are not further detailed herein.

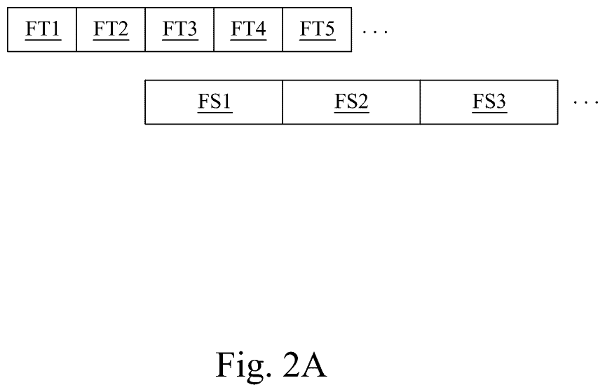

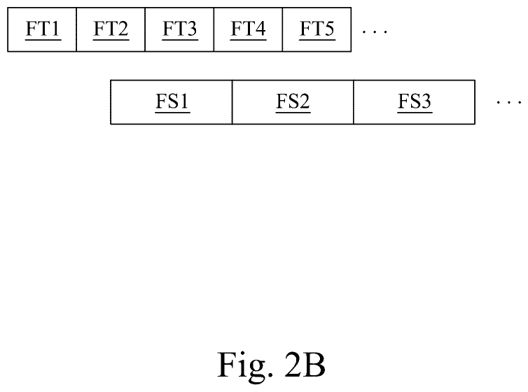

FIG. 2A and FIG. 2B are schematic diagrams of touch frames FT1-FT5 and display frames FS1-FS3 of the display device 100 in some embodiments of the present disclosure. The touch circuit 110 performs detection in each of the touch frames FT1-FT5 to obtain/generate the touch signal St. The driving circuit 120 provides the driving voltage to the display panel 130 in each of the display frames FS1-FS3 according to the touch signal St provided by the touch circuit 110 to update the screen.

In other words, the touch signal St generated by the touch circuit 110 in each of the touch frames FT1-FT5 can be regarded as a screen update. The driving circuit 120 regards the touch signal St obtained in each of the touch frames FT1-FT5 as an image that needs to be updated, and there is an interrelationship between multiple images corresponding to the touch frames FT1-FT5. For example, using “the image corresponding to the touch frame FT1” as the basis, and updating according to the touch signal St of the touch frame FT2 to generate “the image corresponding to the touch frame FT2”.

However, since the sensing frequency of the touch circuit 110, the detection frequency of the driving circuit 120 and the display frequency of the display panel 130 are not necessarily the same, a time length of the touch frame of the the touch signal St obtained by the touch circuit 110 will be different from a time length of the display frame used by the display panel 130 to update the screen.

As shown in FIG. 2A, in one embodiment, a scanning interval of the display panel 130 (the time length of the display frames FS1-FS3) is greater than a sensing interval of the touch circuit 110 (the time length of the touch frames FT1-FT5). Take the touch signal as “handwriting input” as an example, even if the touch circuit 110 quickly recognizes the user's handwriting trace, the speed of the handwriting function is still limited by the update interval of the display panel 130, so the display panel 13 cannot display changes in real time. As shown in FIG. 2A, since the display panel 130 has a relatively long scanning interval, the driving circuit 120 generates a driving voltage according to the touch signals of the two touch frames FT1 and FT2, and then drive the display panel 130 in the same display frame FS1.

The present disclosure changes the scanning method of the display panel 130 (or changes the driving method of the driving circuit 120). Referring to FIG. 1 and FIG. 2B, the driving circuit 120 divides the scan lines L1 into multiple groups or parts, and each part is configured to update different areas on the display panel 130 (i.e., control the pixel circuits PX in different areas). Each part of the scan lines L1 is called “first part, second part . . . ”, such as the odd-numbered rows of the scan lines L1 or the even-numbered rows of the scan lines L1. The driving circuit 120 selectively scans a part of the scan lines L1 in different display frames. Accordingly, the time of the touch frames FT1-FT5 will be shortened to improve the response speed of the display panel 130 in displaying changes in the touch signal.

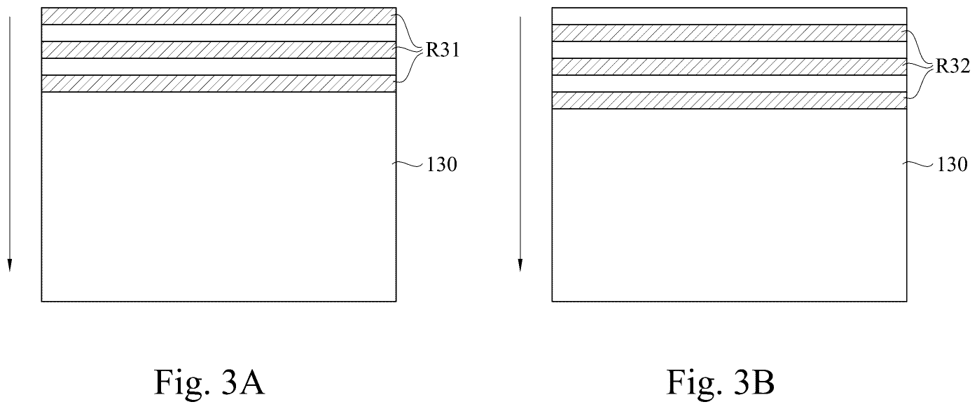

For ease of understanding, FIG. 3A and FIG. 3B are used as examples for explanation. FIG. 3A and FIG. 3B are schematic diagrams of the scanning methods of the display panel 130 in different display frames in some embodiments of the present disclosure. In one embodiment, the scan lines L1 are divided into a first part a the second part. The first part may be an odd-numbered rows of the scan lines, and is configured to update a first area R31 of the display panel 130. The second part may be an even-numbered rows of the scan lines, and is configured to update a second area R32 of the display panel 130. In other words, the first part (the first area R31) and the second part (the second area R32) of the scan lines L1 are arranged staggered (alternately) with each other. However, the present disclosure is not limited to odd-numbered rows or even-numbered rows, and the scan lines L1 can also be divided into multiple staggered parts.

Referring to FIGS. 1, 2B, 3A, 3B, when the driving circuit 120 receives the touch signal St corresponding to the touch frame FT1, the driving circuit 120 first scans the first part of the scan lines L1 in the current display frame FS1, and ignores other parts of the scan lines L1. Accordingly, the driving circuit 120 controls the display panel 130 to update a first image (i.e., corresponding to the the touch signal St of touch frame FT1) in the first area (e.g., the first area R31 shown in FIG. 3A). Since the display panel 130 only updates the first area at this time, the first image will only display a partial image, for example, presented as a dotted line.

Then, the driving circuit 120 continuously receives the touch signal St. At the next display frame FS2, the driving circuit 120 scans the second part of the scan lines L1 according to the received touch signal St (corresponding to the touch frames FT1, FT2, FT3), and ignores other parts of the scan lines L1. Accordingly, the driving circuit 120 controls the display panel 130 to update the first image (i.e., corresponding to the touch signal St of the touch frame FT1) in the second area (e.g., the second area R32 shown in FIG. 3B).

At the same time, since the touch signal St obtained by the driving circuit 120 further includes data corresponding to the touch frames FT2, FT3, when the driving circuit 120 scans the second part of the scan lines L1 in the display frame FS2, the driving circuit 120 further controls the display panel 130 to update a second image and a third image (i.e., corresponding to the touch signal St of the touch frames FT2, FT3) in the second area (e.g., the second area R32 shown in FIG. 3B).

Similarly, in the subsequent display frame FS3, the driving circuit 120 scans the first part of the scan lines L1 according to the received touch signal St (corresponding to the touch frames FT2-FT5, wherein the touch frame FT1 has been updated and can be ignored), and ignores other parts of the scan lines L1. Accordingly, the driving circuit 120 controls the display panel 130 to update the second image, the third image, a fourth image and a fifth image (i.e., corresponding to the touch signal of the touch frames FT2-FT5) in the first area (i.e., the first area R31).

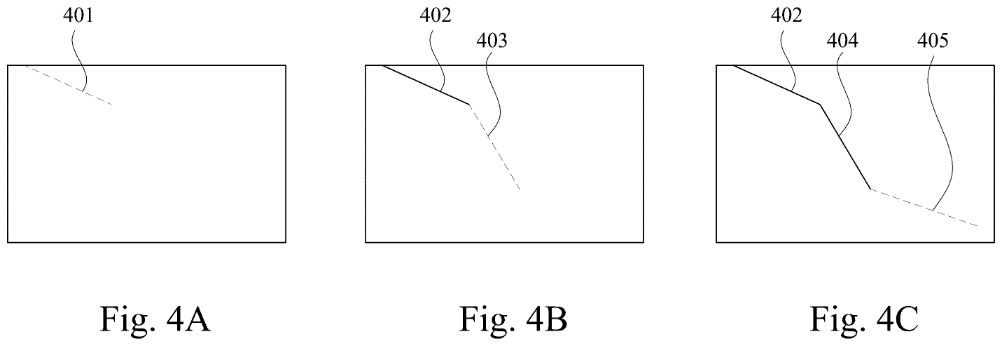

FIGS. 4A-4C are schematic diagrams of image updated by the display panel 130 in some embodiments of the present disclosure. As shown in FIG. 2B and FIG. 4A, in the display frame FS1, the driving circuit 120 scans the first part of the scan lines L1 according to the received touch signal St (corresponding to the touch frame FT1), and ignores other parts of the scan lines L1. Therefore, the screen displayed by the display panel 130 will be a dotted line, as shown in FIG. 4A, the line segment 401.

As mentioned above, in the display frame FS2, the driving circuit 120 scans the second part of the scan lines L1 according to the received touch signal St (corresponding to the touch frames FT1-FT3), and ignores other parts of the scan lines L1. Therefore, the image displayed by the display panel 130 will be a dotted line, but a part of this dotted line is combined with the dotted line displayed in the display frame FS1 (e.g., the line segment 401 shown in FIG. 4A), so as to form a solid line. The screen displayed at this time will be a solid line and a dotted line, such as the line segments 402 and 403 shown in FIG. 4B.

Similarly, in the display frame FS3, the driving circuit 120 scans the second part of the scan lines L1 according to the received touch signal St (corresponding to the touch frames FT1-FT5), and ignores other parts of the scan lines L1. Therefore, the image displayed by the display panel 130 will be a dotted line, but a part of this dotted line is combined with the dotted line displayed in the display frame FS2, so as to form a solid line. The screen displayed at this time will be a solid line and a dotted line, such as the line segments 404, 405 shown in FIG. 4C.

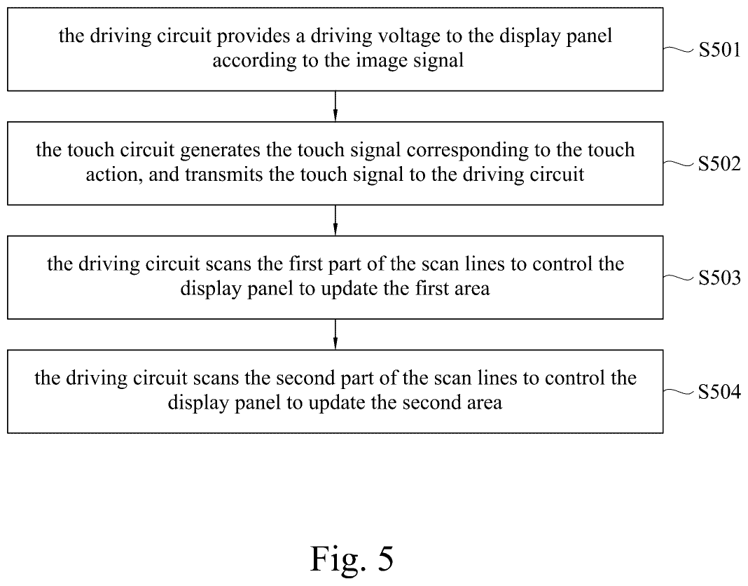

FIG. 5 is a flowchart illustrating an image display method a projection method in some embodiments of the present disclosure, which corresponds to the structure of the display device 100 shown in FIG. 1, and the relative relationship between the display frames and the touch frames is as shown in FIG. 2B. In step S501, the driving circuit 120 provides a driving voltage to the display panel 130 according to the image signal Si, so that the display panel 130 generates the corresponding image.

In step S502, when user touches the touch area of the display device 100 with finger or stylus, the touch circuit 110 generates the touch signal St corresponding to the touch action, and transmits the touch signal St to the driving circuit 120. The touch circuit 110 will continuously detect and generate the touch signal St in multiple touch frames (e.g., the touch frames FT1-FT5 shown in FIG. 2B).

In step S503, in the display frame FS1, the driving circuit 120 scans the first part of the scan lines L1 (e.g., scan the scan lines of odd-numbered rows from top to bottom), so as to control the display panel 130 to update the first image in the first area (the first area R31 shown in FIG. 3A). “The first image” represents the content of the screen that needs to be updated in response to the touch signal St of the touch frame FT1. Specifically, the driving circuit 120 first generates a first update signal according to the received touch signal St (corresponding to the touch frame FT1) in the display frame FS1, and then scans the scan lines L1 according to the first update signal. as shown in FIG. 4A, user inputs a solid line trace by handwriting of the touch frame FT1. However, since the display panel 130 only updates the first area R31 of the screen at this time, the line segment 401 displayed in the display frame FS1 will be a dotted line.

In step S504, in the display frame FS2, the driving circuit 120 scans the second part of the scan lines L1 (e.g., scan the scan lines of even-numbered rows from top to bottom), so as to control the display panel 130 to update the first image, the second image and the third image in the second area (the second area R32 shown in FIG. 3B).

“The second image” and “the third image” represent the content of the screen that needs to be updated in response to the touch signal St in the the touch frames FT2-FT3. As shown in FIG. 4B, user inputs a solid line trace by handwriting of the touch frame FT1. However, since the display panel 130 only updates the second area R32 at this time, the line segment 401 displayed in the display frame FS2 will be a dotted line, but a part of this dotted line is combined with the dotted line updated in the first image to form a solid line (i.e., the line segment 402).

The display device 100 will repeatedly perform the aforementioned steps S502-S504 until no new touch signal St is generated. For example, in the display frame FS3, the driving circuit 120 scans the first part of the scan lines L1 again. Since the first image (i.e., the screen that needs to be updated in response to the touch signal St of the touch frame FT1) has been updated at this time, the driving circuit 120 controls the display panel 130 to update the second image to the fifth image (corresponding to the touch frames FT2-FT5) in the second area (the second area R31 shown in FIG. 3A).

Accordingly, since the display device 100 scans different parts of the scan lines L1 alternately, the scan interval (the time length of the display frames FS1-FS3) of the driving circuit 120 can be shortened, and the screen updates in response to the touch signal St can be presented to the display panel 130 more quickly.

Referring to FIG. 1, in one embodiment, the driving circuit 120 further includes a driving controller 121 and a timing controller 122. The timing controller 122 includes a first buffer 122A and a second buffer 122B. The first buffer 122A and the second buffer 122B respectively support the driving circuit 120 to scan different parts of the scan lines L1. In one embodiment, the driving circuit 120 generates a corresponding update signal for “different parts of the scan lines L1” or “different areas of the screen” (areas R31, R32 shown in FIGS. 3A and 3B) according to the received touch signal St. Therefore, the driving circuit 120 reads the update signal stored in the first buffer 122A and the second buffer 122B, so as to scan the corresponding part of the scan lines L1 and provide the corresponding driving voltage.

For example, referring to FIGS. 2B, 3A and 3B, when the driving circuit 120 receives one or more touch signals St (corresponding to the touch frame FT1), the driving circuit 120 generates a first update signal and a second update signal. The first update signal is a scan signal (scan sequence and driving voltage) of the first image corresponding to the first area R31. The second update signal is a scan signal of the first image corresponding to the the second area R32. The driving circuit 120 stores the first update signal into the first buffer 122A, and stores the second update signal into the second buffer 122B. Accordingly, in the display frame FS1, the driving circuit 120 reads the first update signal to scan the first part of the scan lines L1, so as to control the display panel 130 to update the first area R31. In the display frame FS2, the driving circuit 120 reads the second update signal to scan the second part of the scan lines L1, so as to control the display panel 130 to update the second area R32.

Similarly, when the driving circuit 120 receives other touch signal St (corresponding to the touch frames FT2-FT3), the driving circuit 120 will also generate different image signals in the same way to scan different areas in the display frame. In other words, the driving circuit 120 stores data corresponding to the first part of the scan lines L1 (or corresponding to the first area R31) into the first buffer 122A, and stores data corresponding to the second part of the scan lines L1 (or corresponding to the second area R32) into the second buffer 122B, so as to realize functions of partial scan and partial update.

In addition, in above embodiments, the touch circuit 110, the driving circuit 120 and the display panel 130 are assembled into one body to form the display device 100, but the present disclosure is not limited to this. In some other embodiments, the touch circuit 110 and the driving circuit 120 can also be implemented as an image processing device (e.g., packaged as a single chip or microprocessor), and is communicatively connected to the display panel 130. Similarly, the driving circuit 120 and the display panel 130 can also be independently implemented as the display device 100, and the touch circuit 110 can be implemented as an external input device.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. An image processing device, comprising:
a touch circuit configured to obtain a plurality of touch signals in a plurality of touch frames; and
a driving circuit coupled to the touch circuit to obtain the plurality of touch signals, and coupled to a display panel through a plurality of scan lines, wherein the driving circuit is configured to scan a first part of the plurality of scan lines in a first display frame according to the plurality of touch signals to update a first image in a first area of the display panel;
wherein the driving circuit is configured to scan a second part of the plurality of scan lines in a second display frame according to the plurality of touch signals to update the first image in a second area of the display panel.

2. The image processing device of claim 1, wherein when scanning the second part of the plurality of scan lines in the second display frame, the driving circuit is further configured to update a second image in the second area of the display panel.

3. The image processing device of claim 2, wherein the driving circuit is configured to scan the first part of the plurality of scan lines in a third display frame to update the second image and a third image in the first area of the display panel.

4. The image processing device of claim 1, wherein the first part and the second part of the plurality of scan lines are arranged alternately.

5. The image processing device of claim 4, wherein the first part of the plurality of scan lines is a plurality of odd-numbered rows, and the second part of the plurality of scan lines is a plurality of even-numbered rows.

6. The image processing device of claim 1, wherein the driving circuit comprises a first buffer and a second buffer, the driving circuit is configured to generate a first update signal and a second update signal according to one of the plurality of touch signals, store the first update signal into the first buffer, and store the second update signal into the second buffer;
wherein the driving circuit is configured to read the first update signal in the first buffer to scan the first part of the plurality of scan lines in the first display frame, and read the second update signal in the second buffer to scan the second part of the plurality of scan lines in the second display frame.

7. An image display method, comprising:
obtaining, by a touch circuit, a plurality of touch signals in a plurality of touch frames;
scanning, by a driving circuit, a first part of a plurality of scan lines of a display panel in a first display frame according to the plurality of touch signals to update a first image in a first area of the display panel; and
scanning, by the driving circuit, a second part of the plurality of scan lines in a second display frame according to the plurality of touch signals to update the first image in a second area of the display panel.

8. The image display method of claim 7, wherein scanning the second part of the plurality of scan lines in the second display frame comprises:
scanning the second part of the plurality of scan lines in the second display frame to update a second image in the second area of the display panel.

9. The image display method of claim 8, further comprising:
scanning the first part of the plurality of scan lines in a third display frame to update the second image and a third image in the first area of the display panel.

10. The image display method of claim 7, wherein the first part and the second part of the plurality of scan lines are arranged alternately.

11. The image display method of claim 10, wherein the first part of the plurality of scan lines is a plurality of odd-numbered rows, and the second part of the plurality of scan lines is a plurality of even-numbered rows.

12. The image display method of claim 7, wherein the driving circuit comprises a first buffer and a second buffer, and the image display method further comprises:
generating a first update signal and a second update signal according to one of the plurality of touch signals; and
storing the first update signal into the first buffer, and storing the second update signal into the second buffer.

13. The image display method of claim 12, wherein scanning the first part of the plurality of scan lines in the first display frame comprises:
reading the first update signal in the first buffer to scan the first part of the plurality of scan lines in the first display frame.

14. The image display method of claim 12, wherein scanning the second part of the plurality of scan lines in the second display frame comprises:
reading the second update signal in the second buffer to scan the second part of the plurality of scan lines in the second display frame.

15. A display device, comprising:
a display panel; and
a driving circuit coupled to a touch circuit to obtain a plurality of touch signals, and coupled to a display panel through a plurality of scan lines;
wherein the driving circuit is configured to scan a first part of the plurality of scan lines in a first display frame according to the plurality of touch signals to update a first image in a first area of the display panel;
wherein the driving circuit is configured to scan a second part of the plurality of scan lines in a second display frame according to the plurality of touch signals to update the first image in a second area of the display panel.

16. The display device of claim 15, wherein when scanning the second part of the plurality of scan lines in the second display frame, the driving circuit is further configured to update a second image in the second area of the display panel.

17. The display device of claim 15, wherein the first part and the second part of the plurality of scan lines are arranged alternately.

18. The display device of claim 17, wherein the first part of the plurality of scan lines is a plurality of odd-numbered rows, and the second part of the plurality of scan lines is a plurality of even-numbered rows.
